(19) United States
(12) Patent Application Publication
(10) Pub. No.: US 2007/0171645 A1
(43) Pub. Date: Jul. 26, 2007

(54) Light valve

(75) Inventors: Oscar Hendrikus Willemsen, Eindhoven (NL); Ramon Pascal Van Gorkom, Eindhoven (NL); Antonius Hendricus Maria Holtslag, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,244

(22) PCT Filed: Jun. 2, 2005
(86) PCT No.: PCT/IB05/51792

§ 371 Date: Dec. 8, 2006

(30) Foreign Application Priority Data
Jun. 10, 2004 (EP) 04102652.7

(51) Int. Cl. F21V 33/00

(52) U.S. Cl. 362/253

(57) ABSTRACT

The present invention relates to a light valve (40) for reflecting and diffracting incident light, comprising an electrostatically operable foil (42) provided with a reflective surface (60), a reflective grating structure (52) provided on one side of the foil (42), and means (48, 56, 60) for inducing electrostatic forces on the foil (42) for switching it between a first position, in which the foil is separated from said grating structure (52), whereby incident light (64) received by said light valve (40) will be diffracted by said reflective grating structure (52), and a second position, in which the foil is brought into contact with said grating structure (52), whereby incident light (64) received by said light valve (40) will be essentially specularly reflected by said foil electrode (60). A grating structure having no movable parts may thus be used, which makes the light valve easy to manufacture. The invention also relates to an imaging system comprising at least one such light valve.

The present invention relates to a light valve and an optical imaging system comprising at least one such light valve.

Reflective light valves are for example used in various projection systems. Examples of reflective light valves are the grating light valve (GLV) and the grating electromechanical system (GEMS). GLV and GEMS both use the principle of a switching grating to select a dark or a bright pixel.

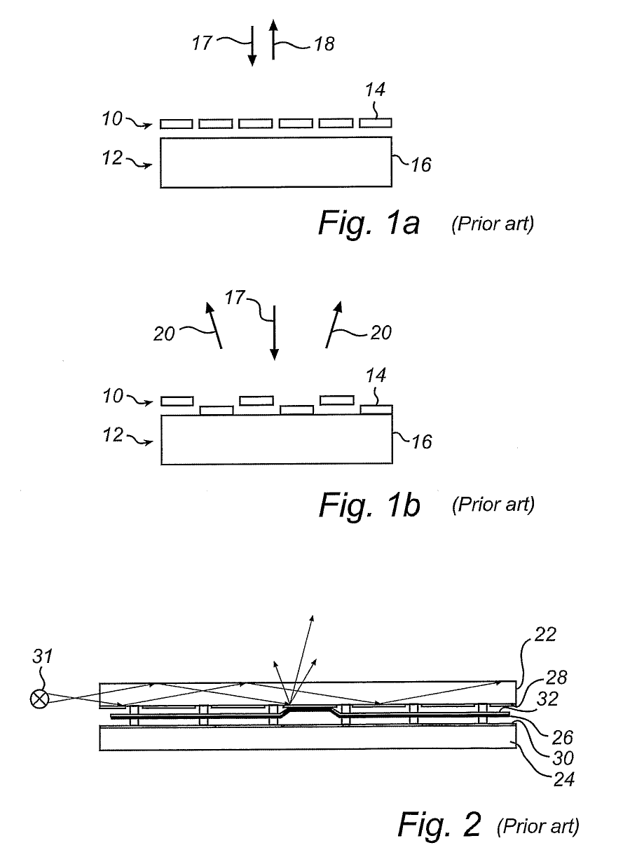

As shown in FIGS. 1a-1b, a grating mechanism 10 of a pixel 12 usually consists of a plurality of movable bars 14 provided on a substrate 16. When all bars are positioned in one plane (FIG. 1a), the pixel 12 acts as a flat mirror, and light incident 17 onto the grating is specularly reflected. On the other hand, when the odd or the even bars of the grating are pulled down by means of electrostatic forces (FIG. 1b), the pixel acts as a grating, implying that incident light 17 constructively interferes under a set of defined angles, the so-called higher order modes. Thus, light incident onto the grating is diffracted.

The specularly reflected light 18 (the 0th order mode) is blocked and the higher order modes 20 are collected with a projection lens and projected onto a screen. Thus, when the pixel acts as a flat mirror, all reflected light is blocked, and the pixel is in an OFF state or dark state. When the pixel acts as a grating, most of the diffracted light is collected by the lens, and the pixel is in an ON state or bright state.

Both the GLV and the GEMS use movable elements that are integrated on a silicon substrate. However, for the creation of these elements, difficult and process-critical lithographic techniques, such as under etching, lift-off and sacrificial layers are necessary. This inherently makes it a process that is sensitive to yield problems and may limit the spatial resolution of the structure.

Another type of display is the foil display. A conventional foil display is described in for example WO 00/38163. Such a display is shown in FIG. 2, and comprises a light guide plate 22 and a non-lit plate 24, with a scattering foil 26 clamped in between. On both plates there are respective sets of parallel electrodes 28, 30 which are arranged perpendicularly with respect to each other. The electrodes on the light guide plate are arranged in a column direction, and the electrodes on the non-lit plate are arranged in a row direction. Also the foil is provided with an electrode layer 32. The electrodes are formed by ITO layers formed on each of the mentioned surfaces. The crossings of the electrodes of each set define the pixels of the display.

By application of voltages to appropriate electrodes on the light guide 22, the non-lit plate 24 and the foil 26, the foil may be attracted to the light guide. When the foil is brought into contact with the light guide, light originating from a light source 31 is extracted from the light guide.

However, since the foil display is based on coupling light out of a light guide, it is not at all suitable for use as a reflective light valve.

An object of the present invention is to provide an improved light valve for reflecting and diffracting incident light, which light valve is robust and easy to manufacture.

According to a first aspect of the invention, this and other objects are achieved by a light valve comprising an electrostatically operable foil provided with a reflective surface, a reflective grating structure provided on one side of the foil, and means for inducing electrostatic forces on the foil for switching it between a first position, in which the foil is separated from said grating structure, whereby incident light received by said light valve will be diffracted by said reflective grating structure, and a second position, in which the foil is brought into contact with said grating structure, whereby incident light received by said light valve will be essentially specularly reflected by said foil electrode.

The invention is based on the understanding that by arranging a reflective foil to interact with a fixed grating structure so that incident light is specularly reflected when the foil lies over the grating and diffracted when the foil is separated from the grating, the grating structure itself does not need to be moved during operation. Thus, a grating structure having no movable parts may be used. The grating structure may for example be a fixed thin structured, highly reflective metal coating, which can be made in one deposition step using straightforward lithography, thus obviating the need for difficult lift-off techniques with sacrificial layers. This obviously makes the light valve easier to manufacture.

Another advantage with the light valve of the invention is that it enables projection of an image with a high contrast ratio since the light valve exhibits a very low dark level.

Preferably, the reflective surface of the foil is constituted by a foil electrode, i.e. the foil electrode is a reflective electrode, for example a metallic layer. An advantage with this is that the foil does not have to be provided with both a separate electrode and a separate reflective surface, which facilitates manufacturing of the light valve.

The means for inducing electrostatic forces on the foil can be an electrode arranged on the other side of the grating structure with respect to the foil. The foil can thus be addressed by applying appropriate voltages to this electrode and the foil electrode to operate the foil towards the front plate. Attraction of the foil away from the front plate may be achieved by electrostatic or mechanical forces, e.g. by means of elastic forces due to elastic properties of the foil.

In another embodiment of the invention, the reflective grating structure is conductive, and constitutes this first electrode. Thus, the grating structure works both as grating and as electrode. An advantage with this is that manufacturing of the light valve is facilitated.

Preferably, the light valve has an elongated shape, which facilitates switching of the foil. Also, the reflective grating structure is preferably arranged perpendicular to the longitudinal direction of the light valve. In other words, the bars of the grating are arranged perpendicular to the long side of the light valve. An advantage with this perpendicular configuration is that, especially for miniaturized pixels, most bars can be illuminated, which improves the quality of the grating. Alternatively, the reflective grating structure can be arranged parallel to the longitudinal direction of the light valve, i.e. the bars of the grating are arranged parallel to the long side of the light valve.

The grating structure can be provided on a front plate, acting as the outer surface of the light valve (facing the incident light). Preferably, also the first electrode is arranged in the front plate.

The light valve can further comprise a back plate arranged on the other side of the foil with respect to the front plate, and the foil can thus be placed between a front and a back plate. Preferably, the foil is separated from the back plate by spacers. In this case, the means for inducing electrostatic forces on the foil are arranged so that the foil lies over the grating structure of the front plate when the foil is in its rest position. Alternatively, the spacers may be positioned between the front plate and the foil, or on both sides of the foil.

The means for inducing electrostatic forces on the foil can further comprise a second electrode arranged on the back plate. The use of two electrodes (besides the foil electrode) enables good addressing capabilities when for example the light valve is arranged in a two-dimensional array of similar light valves. In this case, a drive voltage addressing scheme is preferably used for applying voltages to appropriate electrodes in order to address certain light valves or pixels.

According to another aspect of the invention, an imaging system is provided, which imaging system comprises at least one light valve according to the previous description. The imaging system further comprises a light source for illuminating the at least one light valve, and means for selecting at least one portion of diffracted light from the at least one light valve. Preferably, the selecting means comprises a beam stop, which is arranged to block light that has been specularly reflected from the at least one light valve.

The imaging system can comprise one single light valve, which is arranged to form a single pixel image, whereby the imaging system further comprises a scanner for scanning the pixel image in order to form a two-dimensional image.

The imaging system can alternatively comprise a plurality of light valves forming a one-dimensional array arranged to form a line image, i.e. a “one-dimensional” image, whereby the imaging system further comprises a scanner for scanning consecutive line images in order to form a two-dimensional image.

The plurality of light valves can alternatively form a two-dimensional array. In this case, a complete image is formed, and the scanner can be obviated.

These and other aspects of the present invention will be described in more detail in the following, with reference to the appended figures showing presently preferred embodiments.

FIGS. 1a-1b show a light valve according to prior art,

FIG. 2 shows a foil display device according to prior art,

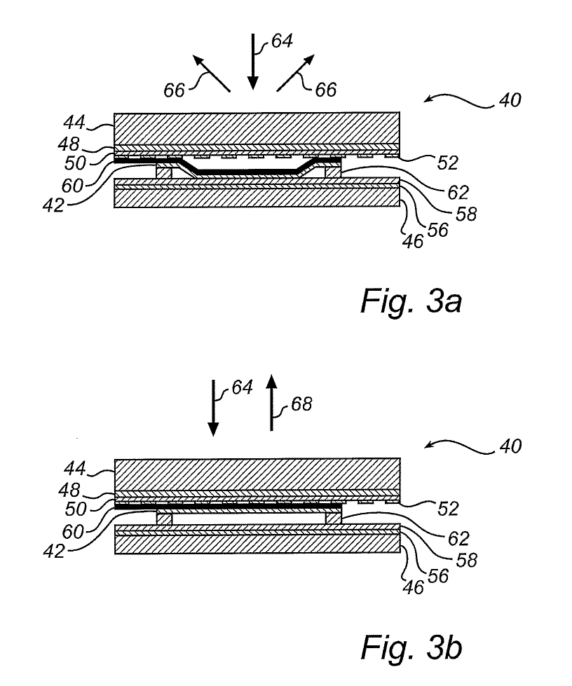

FIG. 3a is a schematic side view of a single light valve according to the invention in an ON state,

FIG. 3b is a schematic side view of the light valve in FIG. 3a in an OFF state,

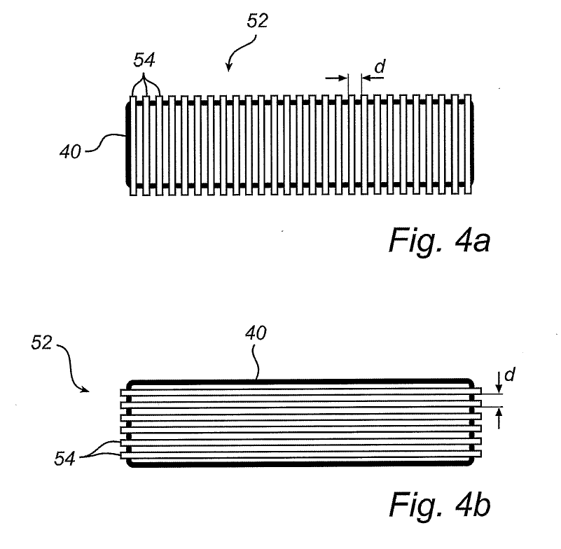

FIGS. 4a-4b are schematic top views illustrating different grating structure configurations,

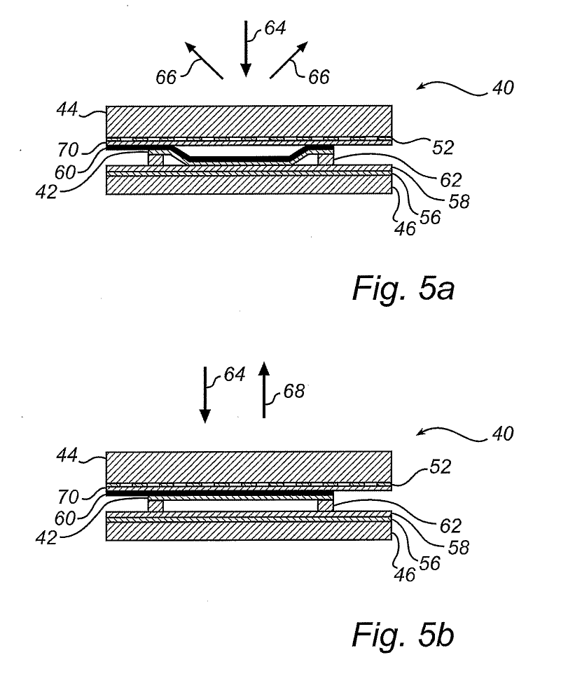

FIGS. 5a-5b are schematic side views of a light valve according to another embodiment of the invention, and

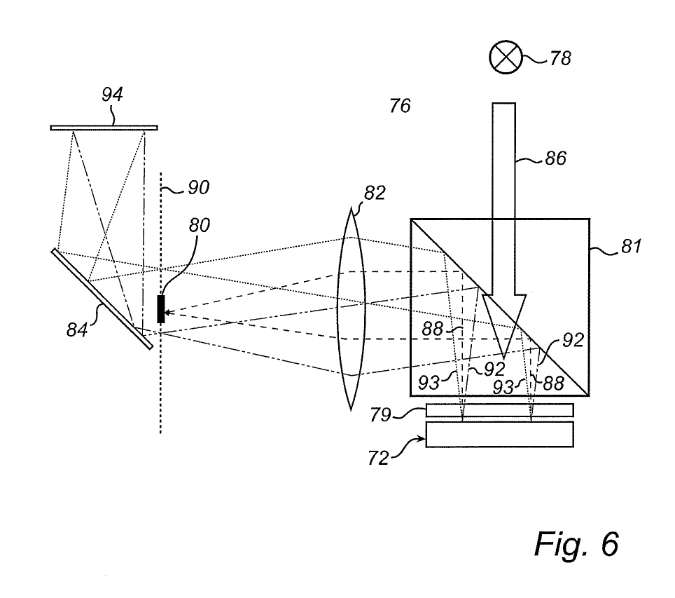

FIG. 6 is a schematic view of an optical system comprising at least one light valve.

A single light valve or pixel according to the invention is schematically shown in FIGS. 3a-3b. Identical reference numerals have been used for corresponding elements of the light valve.

The light valve 40 in FIGS. 3a-3b comprises an electromechanically operated foil 42, which is clamped in between a front plate 44 and a back plate 46. The front plate 44 is preferably made by glass, and at least the front plate is transparent regarding light from a light source (not shown). The back plate 46 can be any material.

The front plate 44 is provided with a transparent electrode 48 on the side of the front plate facing the foil 42. The electrode 48 may be formed by an ITO layer. The electrode 48 is covered by a dielectric layer 50, which for example may be made of SiO₂. On top of the dielectric layer, a thin structured, highly reflective metal coating 52 is provided. This metal coating consists of a number of elongated rectangular bars that act as a grating, and the coating is made thick enough to reflect incident light. Typically, the thickness of the coating is about 50 nm. The metal coating, i.e. the grating, may be deposited on the dielectric layer using basic lithography.

Different layouts of the reflective grating structure 52 is further detailed in FIGS. 4a-4b. FIGS. 4a and 4b each shows a top view of a light valve 40 having an elongated rectangular shape. The size of the light valve 40, i.e. the size of the pixel, is for example 100 by 600 μm. Also shown is the grating 52, which consists of a plurality of elongated rectangular metallic bars 54. The distance between each bar, i.e. the pitch of the grating, is denoted d. In FIG. 4a, the grating structure 52 is arranged perpendicular to the longitudinal direction of the light valve 40. In other words, the bars 54 of the grating structure 52 are arranged perpendicular to the long side of the light valve. Alternatively, in FIG. 4b, the grating structure 52 is arranged parallel to the longitudinal direction of the light valve 40, i.e. the bars 54 of the grating are arranged parallel to the long side of the light valve.

Returning to FIGS. 3a-3b, the back plate 46 is further provided with an electrode 56 on the side of the back plate facing the foil 42. The electrode 56 may be a non-transparent electrode. The electrode 56 is optionally covered by a dielectric layer 58.

The foil 42 positioned between the front plate 44 and the back plate 46 is provided with a metallic layer 60 on the side of the foil facing the grating 52 of the front plate. The metallic layer on the foil acts both as an electrode and as a light reflector. The foil 42 can be actuated by applying proper voltages to the electrodes 48, 56, and 60.

In FIGS. 3a-3b, the foil 42 is separated from the back plate 46 by means of spacers 62. In this case, the foil 42 is pressed against the front plate 44 when the foil is in its rest position. Preferably, the height of the spacers 62 corresponds to a quarter of the wavelength of the incident light. The height of the spacers are generally in the range of about 100 nm to 2 μm. As an alternative to the positioning of the spacers 62 shown in FIGS. 3a-3b, the spacers may be positioned between the front plate and the foil, or on each side of the foil.

The operation of the light valve 40 will now be described for two different states shown in FIG. 3a and FIG. 3b respectively.

When the light valve 40 is in the first state (FIG. 3a), the foil 42 is drawn towards the back plate 46 by applying appropriate voltages to the electrodes 48, 56, and 60. In this state, a light beam 64 that incides perpendicularly towards the front plate will “see” a reflective grating having a pitch d, i.e. the grating 52. The grating 52 causes the incident light to be diffracted at defined angles given by:
n·d·sin θ=m·λ (1)
where n is the index of refraction, d is the grating pitch, θ is the angle of the order, m is the order number, and λ is the wavelength of the incident light.

The light diffracted and reflected by the reflective grating 52, the so-called higher order modes, is designated 66 in FIG. 3a, and may after diffraction/reflection be received by a focusing lens (not shown) as will be described later on. This first state is defined as the “ON” state or the bright state of the pixel.

When the light valve 40 is in the second state (FIG. 3b), the foil 42 is drawn towards the front plate 44 so that the foil lies over the grating 52. This is achieved by applying appropriate voltages to the electrodes 48, 56, and 60. In this state, since the reflective metallic layer 60 of the foil 42 is pressed to the grating 52 of the front plate, a light beam 64 that incides perpendicularly towards the front plate will “see” an essentially flat mirror, and the light will be essentially specularly reflected. The specularly reflected light, i.e. the 0th order mode, is designated 68 in FIG. 3b, and may after reflection be received by a beam stopper (not shown) as will be described later on. This second state is defined as the “OFF” state or the dark state of the pixel.

However, since the fitting of the grating 52 and the reflective metallic layer of the foil never is prefect, a diffractive structure having a pitch 0.5d is also present in this state.

It should also be noted that the space between the glass plates 44, 46 can be evacuated to improve the switching speed of the foil of the light valve.

According to another embodiment, illustrated in FIGS. 5a-5b, the transparent electrode of the front plate 44 has been removed. Instead the grating 52 will act as the electrode. However, in this case, the grating/electrode 52 must be isolated from the foil electrode 60. In FIGS. 5a-5b, this is achieved by covering the grating 52 with a dielectric layer 70 that isolates the grating/electrode 52 from the foil electrode 60. The layer has such thickness that it equals an optical path length of 0.5 times the wavelength of the light used. In an alternative solution (not shown), the grating/electrode is isolated from the foil electrode by placing the foil electrode on the other side of the foil, i.e. the side of the foil facing the back plate. In this case, the foil must be metallic so that it can act as a mirror in the OFF state. Also, the back plate must be covered with a dielectric layer.

FIG. 6 shows a schematic view of an optical imaging system 76 used to project an image onto a screen. The system 76 comprises an array 72 of at least one light valve. In the following, it is assumed that the array comprises a plurality of light valves, which light valves or pixels may be of any type described above. In addition to the array 72 of light valves, the optical system 76 comprises a light source 78, such as a laser or LED light source, provided with means (not shown) to generate light polarized in one direction. A polarizing beam splitter 81, aligned with the polarization direction of the light, and a ¼λ plate 79 (i.e. a plate having a thickness equal to ¼ of the wavelength of the incident light), are arranged in the light path. After passing the beam splitter 81 and plate 79, light from the light source illuminates the array 72. The system further comprises a projection lens 82 and a beam stop 80 arranged in the focal point of the lens 82 (Schlieren stop) positioned at the focal point in the focal plane 90 of the projection lens 82, and a mirror scanner 84.

Upon operation of the optical system 76, polarized light from the light source 78 passes the beam splitter 81 and the ¼λ plate 79. The ¼λ plate 79 is oriented at 45 degrees with respect to the polarization direction of the incoming light, in order to transform the polarized light from the light source into circularly polarized light. The light is selectively specularly reflected or diffracted by the light valves of the array 72, and then again passes the ¼λ plate 79. This time the ¼λ plate transforms the circularly polarized light into light polarized in a direction perpendicular to the polarization direction of the incoming light. The reflected (or diffracted) light is therefore reflected by the beam splitter 81.

Light 88 reflected specularly (0th order mode) from the light valves in the OFF state is reflected towards the projection lens 82 in a direction which is parallel to the optical axis of the projection lens 82. Thus, the specularly reflected light from different light valves is focused at the focal point in the focal plane 90 of the projection lens 82, and is absorbed by the beam stop 80.

Light diffracted by the light valves in the ON state (for example the positive and negative first order diffractions 92 and 93) will be reflected towards the projection lens 82 with directions that are non-parallel to the optical axis of the projection lens 82, and will thus not be directed into the focal point (where the beam stop is). Corresponding diffraction beams, e.g. the positive first order modes 92 will share a common angle of incidence towards the projection lens 82, and therefore cross each other in the focal plane. The positive and negative first order modes 92 and 93 originating from one and the same light valve of the array 72 will in turn be focused in a plane beyond the focal plane 90 of the focusing lens 82, where they will form an image. In the illustrated example, these beams are first reflected by the mirror scanner 84, before they are focused in the image plane 94.

It should be noted that the above mentioned array of light valves can be “zero-dimensional” (i.e. one single light valve), one-dimensional or two-dimensional. In the case of a single light valve or pixel, the scanning mirror is two-dimensional, and in the case of a one-dimensional array, the scanning mirror is one-dimensional, in order to form a two-dimensional image that may be projected onto a projection screen. In the case of a two-dimensional array, the light valve array 72 creates the entire image and the scanning mirror can be obviated all together. The light valves of the array can be addressed using some type of matrix addressing by means of the electrodes 48 and 56.

It should also be noted that it is possible to use a non-polarizing beam splitter instead of the ¼λ plate 79 and the polarizing beam splitter 81. However, the use of a non-polarizing beam splitter is less effective, as 75% of the light will be lost.

Also, the optical system in FIG. 6 may alternatively be arranged so that light from the light source incides obliquely towards the array of light valves, i.e. not essentially perpendicularly as shown in FIG. 6. In this case, the projection lens is arranged so that specularly reflected light from the array incides towards the projection lens in a direction which is essentially parallel to the optical axis of the projection lens. The ¼λ plate 79 and the polarizing beam splitter 81 can be obviated in this case.

For reason of efficiency, it may be beneficial to image also the higher order modes, i.e. not only the first order modes as described above. However, the second order mode is diffracted under the same angle as the first order mode of the grating structure that is created in the OFF state of the pixel. The same holds for every even mode of the grating. Hence, these orders have to be intercepted by the Schlieren stop.

However, in practice it will be sufficient to image the first order modes and still have a high efficiency of the imaging system. If a higher efficiency is desired, also the third order modes can be captured, especially when the grating is not perfectly rectangular due to bending of the foil. These modes have to be collected by the projection lens, which preferably has an aperture (F/#) of 2 or higher. This implies that the largest angle that still can be captured is 14 degrees. By using equation 1, it can be deduced that the pitch of the grating should at least be 13 times the wavelength of the used light in order to capture the third order modes. For green light, this implies a minimal grating pitch d of 7 μm and minimal width of the metallic bars of 3.5 μm. If only the first order modes need to be captured, a minimal grating pitch d of 2.5 μm is acceptable.

The minimal pitch is an important parameter that ultimately limits the contrast of the imaging system. For a desired pixel size the grating pitch determines the number of metallic bars that fit in a pixel. This number in the end determines the quality of the grating and in this way the discrimination level (=contrast) of the imaging system.

The invention is not limited to the embodiments described above. Those skilled in the art will recognize that variations and modifications can be made without departing from the scope of the invention as claimed in the accompanying claims.

1. A light valve (40) having at least two states for reflecting and diffracting incident light, comprising:
an electrostatically operable foil (42) provided with a reflective surface (60),
a reflective grating structure (52) provided on one side of the foil (42), and
means (48, 56, 60) for inducing electrostatic forces on the foil (42) for switching it between a first position, in which the foil is separated from said grating structure (52), whereby incident light (64) received by said light valve (40) will be diffracted by said reflective grating structure (52), and a second position, in which the foil is brought into contact with said grating structure (52), whereby incident light (64) received by said light valve (40) will be essentially specularly reflected by said foil electrode (60).

2. A light valve according to claim 1, wherein said reflective surface (60) is formed by a foil electrode layer.

3. A light valve according to claim 1, wherein said means for inducing electrostatic forces on the foil comprise a first electrode (48) arranged on the other side of the grating structure (52) with respect to the foil (42).

4. A light valve according to claim 3, wherein said reflective grating structure (52) is conductive, and constitutes said first electrode (48).

5. A light valve according to claim 1, wherein said light valve (40) has an elongated shape, and wherein said reflective grating structure (52) is arranged perpendicular or parallel to the longitudinal direction of the light valve.

6. A light valve according to claim 1, wherein said grating structure (52) is provided on a front plate (44).

7. A light valve according to claim 1, further comprising a back plate (46) arranged on the other side of the foil (42) with respect to the grating structure (52).

8. A light valve according to claim 7, wherein said means for inducing electrostatic forces on the foil further comprise a second electrode (56) arranged on said back plate (46).

9. A light valve according to claim 6, wherein the foil is separated from at least one of said front plate and said back plate by spacers (62).

10. A light valve according to claim 8, wherein spacers (62) are arranged between said foil (42) and said second electrode (56).

11. An imaging system (76), comprising:
at least one light valve (40) according to claim 1,
a light source (78) arranged to illuminate said at least one light valve, and
means (80, 82) for selecting at least one portion of diffracted light from said at least one light valve.

12. An imaging system according to claim 11, wherein said selecting means comprises a beam stop (80) arranged to block light that has been specularly reflected from said at least one light valve.

13. An imaging system according to claim 11, comprising one single light valve (40) arranged to form a single pixel image, and wherein said system further comprises a scanner (84) for scanning said pixel image to form a two-dimensional image.

14. An imaging system according to claim 11, comprising a plurality of light valves forming a one-dimensional array (72) arranged to form a line image, and wherein said system further comprises a scanner (84) for scanning consecutive said line images to form a two-dimensional image.
